(19) United States
(12) Patent Application Publication
(10) Pub. No.: US 2002/0043778 A1
(43) Pub. Date: Apr. 18, 2002

(54) Skateboard with vibration-absorbing function

(76) Inventor: Shih-Ming Huang, Chang-Hua Hsien (TW)

Correspondence Address: Ying-Cheng Lu, P.O. Box No.6-57, Chung-Ho, Taipei, 235, TW

(21) Appl. No.: 10/014,868

(22) Filed: Dec. 14, 2001

(51) Int. Cl. B62M 1/00

(52) U.S. Cl. 280/87.042

(57) ABSTRACT

A skateboard with vibration-absorbing function comprises a platform, a coupling stage formed on bottom center of the platform, two swing members connected to two distal ends of the coupling stage, at least two resilient members arranged between the coupling stage and the swing members, at least two wheels, each arranged below the swing member and corresponding to the resilient member. The resilient members provide vibration-absorbing function to the skateboard.

### BACKGROUND OF THE INVENTION

1) Field of the Invention

The present invention relates to a skateboard, especially to a skateboard with vibration-absorbing function.

2) Description of the Prior Art

The conventional skateboard, as shown in FIG. 1, generally comprises a platform 1 and a plurality of wheels 11 on two bottom ends of the platform 1. The platform 1 has two up-bending ends 12 on front end and rear end thereof for facilitating fancy performance. The wheels 11 are supported through underprops 111 and L-racks 112 below the platform 1, wherein the underprops 111 and the L-racks 112 are resiliently mounted below the platform 1. When a pressure is exerted on one side of the platform 1, the L-racks 112 push the hub 110 of the skateboard to turn the skateboard.

The platform 1 is of generally elongating shape and made of rigid material. Moreover, the user generally put his heel atop the wheel 11. Therefore, the vibration due to rough road is directly transmitted to user's heel through the wheel 11. Once there is a big kettle on the road, the user may slide and the platform 1 has the risk of damage.

### SUMMARY OF THE INVENTION

It is an object of the present invention to provide a skateboard with vibration-absorbing function.

In one aspect of the invention, the skateboard has a horizontal platform with a coupling stage formed on bottom center of the platform, two swing members with corresponding resilient member are arranged to provide vibration-absorbing function.

In another aspect of the invention, each swing member has a retaining rod extended toward the coupling stage and clamped by a confining section arranged in the coupling stage. The swing member is retained by the retaining rod to prevent excessive expansion.

In another aspect of the invention, the resilient member can be implemented by air bag, rubber or other resilient material other than spring.

The various objects and advantages of the present invention will be more readily understood from the following detailed description when read in conjunction with the appended drawing, in which:

### BRIEF DESCRIPTION OF THE DRAWINGS

FIG. 1 shows a prior art skateboard;

FIG. 2 shows a sectional view of the present invention;

FIG. 3 shows a front view of the present invention;

FIG. 4 shows a partial perspective view of the present invention;

FIG. 5 shows another preferred embodiment of the present invention; and

FIG. 6 shows still another preferred embodiment of the present invention;

FIG. 7 shows still another preferred embodiment of the present invention; and

FIG. 8 shows still another preferred embodiment of the present invention.

### DETAILED DESCRIPTION OF THE PREFERRED EMBODIMENTS

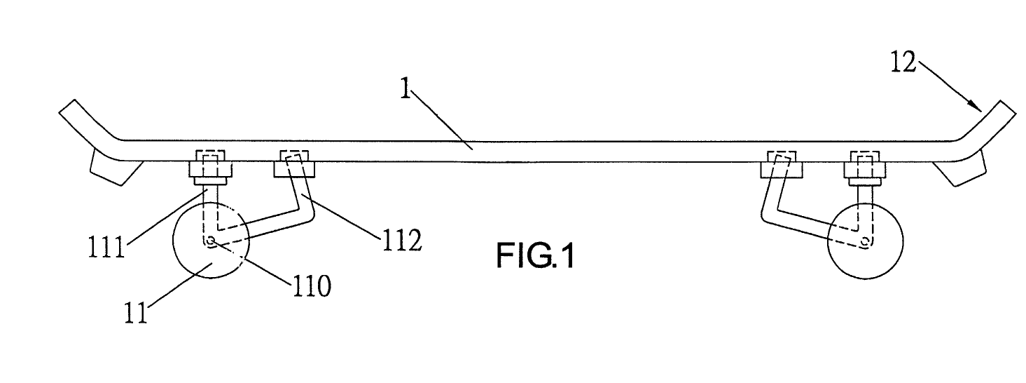

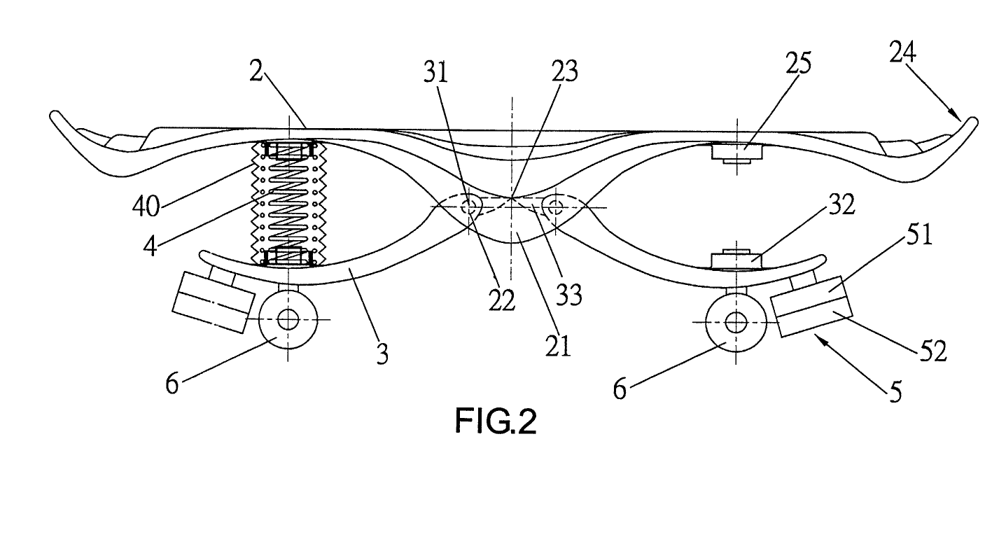

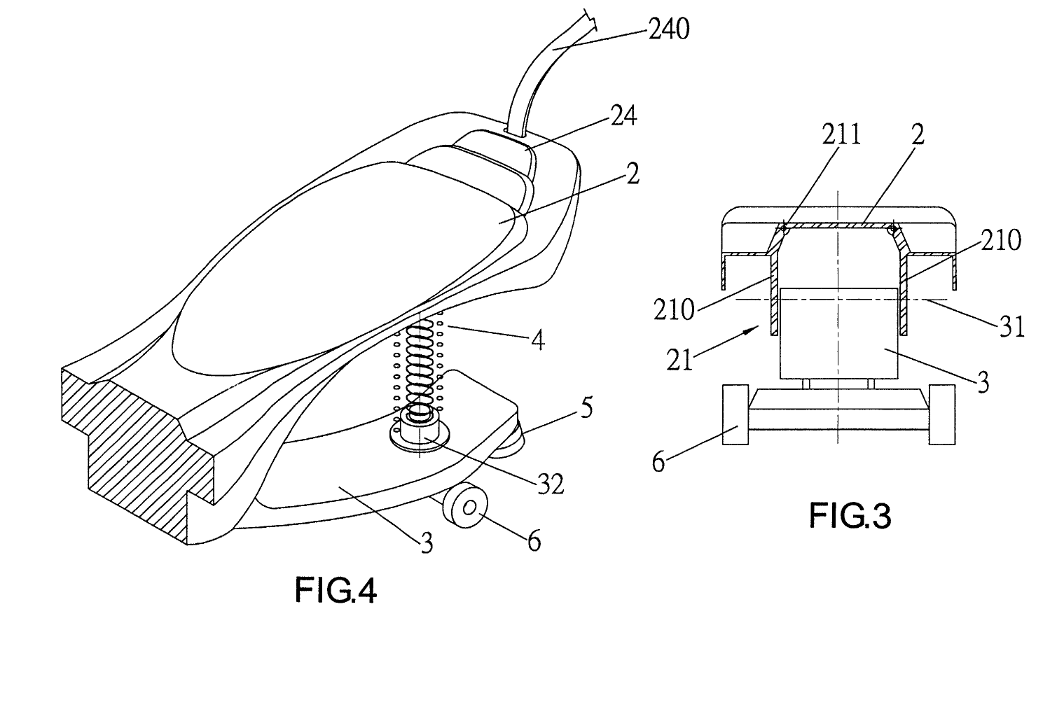

FIGS. 2 and 3 show sectional view and front view of the present invention after assembling. The skateboard of the present invention generally comprises a platform 2 and a coupling stage 21 formed on bottom center of the platform 2. The coupling stage 21 has two axial holes 22 on both sides thereof. Two flat-shape swing members 3 are connected to the two axial holes 22 through pivot pins 31. Each swing member 3 has a retaining rod 33 extended toward the coupling stage 21 and clamped by a confining section 23 arranged in the coupling stage 21. The swing member 3 is retained by the retaining rod 33 to prevent excessive expansion. Moreover, the platform 2 and the swing members 3 are provided with connecting sections 25, 32 corresponding to position of wheels 6, as shown in FIG. 2. A resilient member 4 is arranged between the connecting sections 25, 32. The resilient member 4 can be, for example, spring and covered with a flexible dust cover 40. The skateboard of the present invention has wheels 6 arranged below the resilient member 4. The wheels 6 can provide sliding and turning function for the skateboard and the turning mechanism is described in above section with reference to FIG. 1.

In the skateboard of the present invention, the wheels 6 can provide sliding and turning function for the skateboard and the resilient member 4 absorbing vibration as the skateboard slides along a rough surface. Moreover, the pivot pins 31 are located at the vertical bisecting lines of the resilient member 4 such that the resilient member 4 may not be skew as absorbing vibration.

The retaining rod 33 is provided to prevent the detachment of the resilient member 4 as the swing member 3 swing with respect to the platform 2. For assembling the skateboard of the present invention, the swing member 3 is assembled after the resilient member 4 is arranged. To assemble the swing member 3 on the axial holes 22 of the coupling stage 21, the resilient member 4 is slightly depressed to align the axial holes 22 of the coupling stage 21 with the axial holes (not shown) of the swing members 3 and then the pivot pins 31 are inserted into the axial holes. Afterward, the resilient member 4 is relaxed to provide an elastic force to clamp the swing member 3.

The resilient member 4 can be implemented by air bag, rubber or other resilient material other than spring.

In case that the platform 2 is made by injection molding of plastic material, a plurality of coupling plates 210 are vertically arranged to the platform 2, as shown in FIG. 3. Moreover, a plurality of tubular metallic supporters 211 are embedded into the platform 2 to reinforce the mechanical structure of the platform 2.

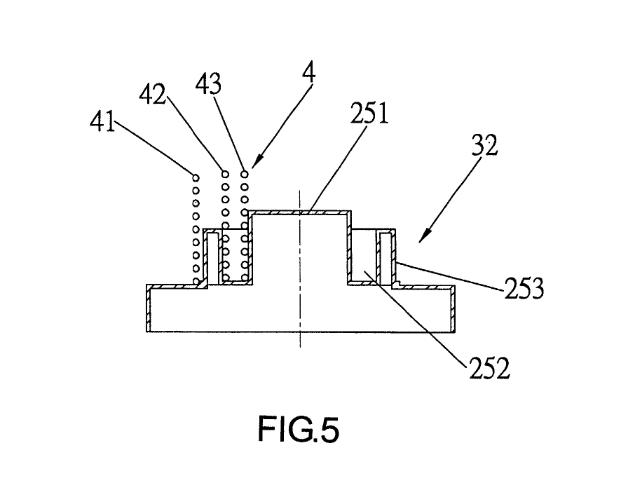

With reference now to FIG. 4, the flat-shape swing member 3 has a braking section 5 on rear end thereof. When user steps on a rising end 24 of the platform 2, the platform 2 is tilted and the braking section 5 is in contact with ground to provide braking function. Moreover, the braking section 5 can be implemented by a base 51 with a rotor 52 below the base 51. The rotor 52 provides skew movement of the platform 2 and the wheels 6 are lifted above ground when the bottom surface of the rotor 52 is in contact with ground, whereby the user can perform fancy rotatory play.

With reference now to FIG. 5, each of the connecting sections 25, 32 comprises a connecting tenon 251, a connecting ring 253 and a connecting groove 252 formed between the connecting tenon 251 and the connecting ring 253. The resilient member 4 comprises a plurality of spring 41, 42, 43 with different diameters and corresponding to the diameter of the connecting tenon 251, the connecting groove 252 and the connecting ring 253. Therefore, the plurality of spring 41, 42, 43 can be selectively arranged to provide up to seven different composite elastic coefficients.

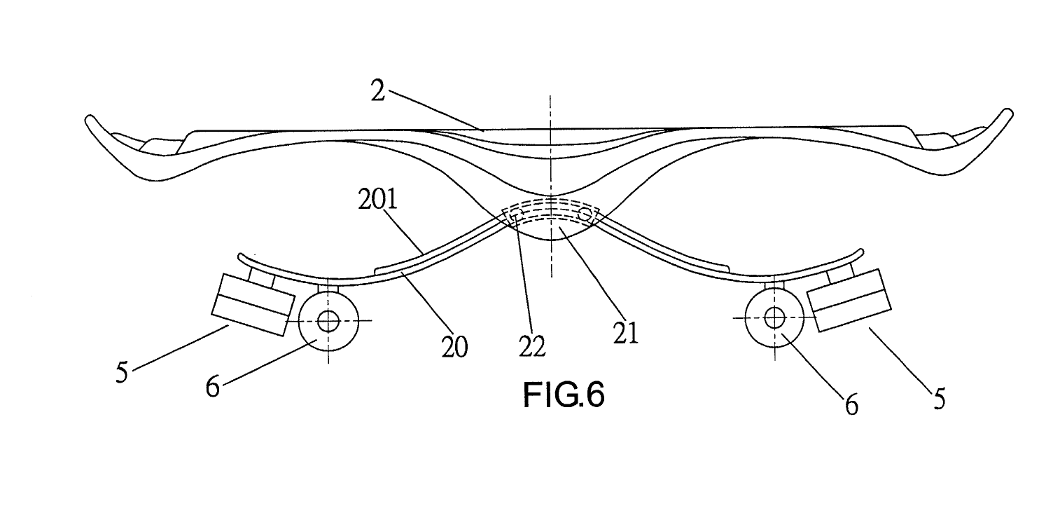

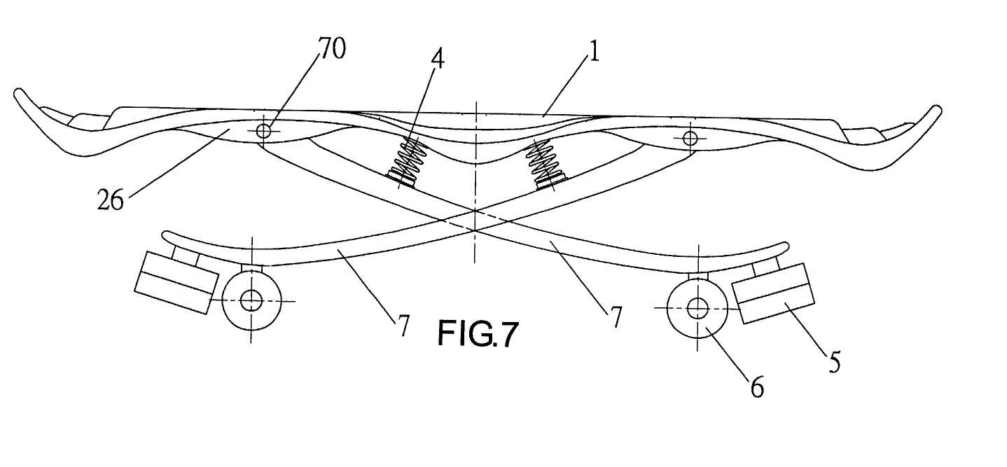

With reference now to FIG. 6, a flexible swing plate 20 is directly assembled to the coupling stage 21 to provide vibration-absorbing function and the wheels 6 are arranged below the flexible swing plate 20. More particularly, the center portion of the flexible swing plate 20 is assembled to the coupling stage 21. Alternatively, the flexible swing plate 20 is assembled to the axial holes 22 of the coupling stage 21 with suitable hardware. Moreover, the flexible swing plate 20 can be implemented in composite way or auxiliary plates 201 are stacked on the flexible swing plate 20 to change the flexibility and curvature of the flexible swing plate 20.

FIG. 7 shows still another preferred embodiment of the present invention. The platform 1 has coupling stages 26 on two lateral sides thereof and a coupling plate 7 is linked to the coupling stages 26 through a pivotal rod 70. The coupling plate 7 has a braking section 5 and a wheel 6 on a free end thereof. The coupling plate 7 further has a resilient member 4 on an inner surface thereof facing the platform 1. The coupling plate 7 provides crossing force to the platform 1.

Moreover, the coupling plate 7 is of elongate shape and made of resilient material. The coupling plate 7 has a pivotal end fixed to the platform 1 and another end functions as a free end by virtue of the flexibility of the coupling plate 7.

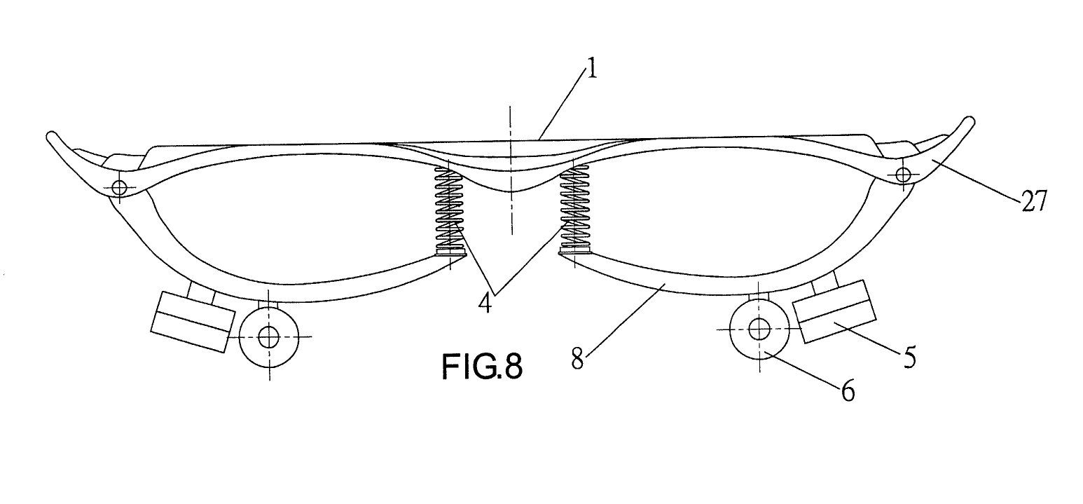

FIG. 8 shows still another preferred embodiment of the present invention. To provide more flexible vibration mode to the skateboard, the swing members are two inner swing members 8. Each of the inner swing members 8 has an outer end pivotally connected to a coupling stage 27 on outer end of the platform 1 and an inner free end coupled to the platform 1 through a resilient member 4. Each of the inner swing members 8 further has a braking section 5 and a wheel 6 on bottom thereof.

Moreover, the resilient member 4 can be realized by air sac with different pneumatic pressure therein to provide different flexibility.

The skateboard of the present invention has vibration-absorbing function and the resilient force provided by the resilient member 4 facilitates fancy play of user. As shown in FIG. 4, an operative cord 240 can be provided for beginning user to facilitate operation and fancy play.

Although the present invention has been described with reference to the preferred embodiment thereof, it will be understood that the invention is not limited to the details thereof. Various substitutions and modifications have suggested in the foregoing description, and other will occur to those of ordinary skill in the art. Therefore, all such substitutions and modifications are intended to be embraced within the scope of the invention as defined in the appended claims.

1. A skateboard with vibration-absorbing function, comprising a platform,
a coupling stage formed on bottom center of the platform;
two swing members connected to two distal ends of the coupling stage;
at least two resilient members arranged between the coupling stage and the swing members;
at least two wheels, each arranged below the swing member and corresponding to the resilient member.

2. The skateboard with vibration-absorbing function as in claim 1, wherein one swing member has a braking section on rear end thereof.

3. The skateboard with vibration-absorbing function as in claim 1, wherein the swing member has a retaining rod extended toward the coupling stage and clamped by a confining section arranged in the coupling stage.

4. The skateboard with vibration-absorbing function as in claim 1, wherein a plurality of supporters are embedded into the platform to reinforce the mechanical structure of the platform.

5. The skateboard with vibration-absorbing function as in claim 1, wherein the resilient member is covered with a flexible dust cover.

6. A skateboard with vibration-absorbing function, comprising
a platform,
a coupling stage formed on bottom center of the platform;
a flexible swing plate connected to the coupling stage;
two wheels arranged below the flexible swing plate.

7. The skateboard with vibration-absorbing function as in claim 6, wherein the flexible swing plate has a braking section on rear end thereof.

8. The skateboard with vibration-absorbing function as in claim 6, wherein the flexible swing plate is formed by composite stacking plates.

9. The skateboard with vibration-absorbing function as in claim 1, wherein the platform has two crossing and elongated coupling plates below and the coupling plates are pivotally connected to the platform.

10. The skateboard with vibration-absorbing function as in claim 1, wherein the swing members are two inner swing members.

11. The skateboard with vibration-absorbing function as in claim 1, wherein the resilient member is an air sac.

12. The skateboard with vibration-absorbing function as in claim 1, wherein the braking section is a base with a rotor.
